(19) United States
(12) Patent Application Publication
(10) Pub. No.: US 2013/0249738 A1
(43) Pub. Date: Sep. 26, 2013

(54) MULTI-BAND ANTENNA

(71) Applicants: YI-FENG HUANG, New Taipei City (TW); Jia-Hung Su, New Taipei City (TW); Kai Shih, New Taipei City (TW)

(72) Inventors: YI-FENG HUANG, New Taipei City (TW); Jia-Hung Su, New Taipei City (TW); Kai Shih, New Taipei City (TW)

(73) Assignee: Cheng Uei Precision Industry Co., LTD., New Taipei City (TW)

(21) Appl. No.: 13/429,372

(22) Filed: Mar. 24, 2012

(51) Int. Cl. H01Q 1/38

(52) U.S. Cl. 343/700 MS

(57) ABSTRACT

A multi-band antenna disposed on a circuit board includes a feeding portion located on a left side of the circuit board and adjacent to a front edge of the circuit board. A base slice is located on the left side of the circuit board and connected with a rear end of the feeding portion. A high frequency radiating portion is located on the left side of the circuit board and connected with a left end of the base slice. A low frequency radiating portion is connected with a rear end of the base slice and zigzag meanders opposite to the high frequency radiating portion. A mid-frequency radiating portion is connected with the rear end of the base slice and then straightly extends towards a right edge of the circuit board.

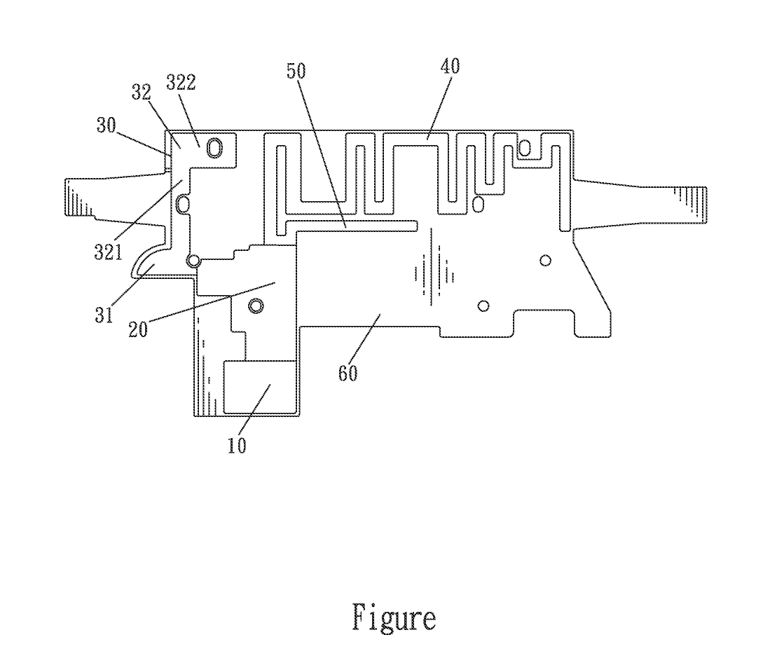

### BACKGROUND OF THE INVENTION

1. Field of the Invention

The present invention relates to a multi-band antenna, and more particularly to a multi-band antenna capable of conforming to the miniaturization trend of electronic products.

2. The Related Art

With the fast development of mobile communication technology, people put forward more and more requirements on portable mobile communication equipments, such as mobile phones and notebooks, especially in miniaturization volume of the portable mobile communication equipments. With the volume of the portable mobile communication equipment becoming smaller and smaller, the size of an antenna placed in the equipment should be accordingly decreased. In order to both conform to the miniaturization trend of the portable mobile communication equipment and ensure the effective performance of the antenna, it is necessary to provide a kind of rational layout of multi-band antenna.

### SUMMARY OF THE INVENTION

An object of the present invention is to provide a multi-band antenna disposed on a circuit board. The multi-band antenna includes a feeding portion of a substantially rectangular slice shape located on a left side of the circuit board and adjacent to a front edge of the circuit board. A base slice is located on the left side of the circuit board and connected with a rear end of the feeding portion. A high frequency radiating portion is located on the left side of the circuit board and connected with a left end of the base slice. The high frequency radiating portion is further adjacent to a left edge and a rear edge of the circuit board. A low frequency radiating portion is connected with a rear end of the base slice and zigzag meanders opposite to the high frequency radiating portion along the rear edge of the circuit board. A free arm of the low frequency radiating portion is adjacent to a right edge of the circuit board. A mid-frequency radiating portion is connected with the rear end of the base slice and then straightly extends towards the right edge of the circuit board.

As described above, the multi-band antenna utilizes the rational layout of the high frequency radiating portion, the low frequency radiating portion and the mid-frequency radiating portion on the circuit board to receive and transmit communication signals of different frequency bands of 2300-2700 MHZ, 791-960 MHZ, and 1710-2170 MHZ. So the multi-band antenna is capable of conforming to the miniaturization trend of electronic products and further ensures the effective performance thereof.

### BRIEF DESCRIPTION OF THE DRAWINGS

The present invention will be apparent to those skilled in the art by reading the following description, with reference to the attached drawing, in which:

The FIGURE is a vertical view of a multi-band antenna in accordance with an embodiment of the present invention.

### DETAILED DESCRIPTION OF THE PREFERRED EMBODIMENT

Referring to the FIGURE, a multi-band antenna according to an embodiment of the present invention is shown. The multi-band antenna is disposed on a circuit board 60 and includes a feeding portion 10, a base slice 20, a high frequency radiating portion 30, a low frequency radiating portion 40 and a mid-frequency radiating portion 50.

Referring to the FIGURE, the feeding portion 10 of a substantially rectangular slice shape is located on a left side of the circuit board 60 and is further adjacent to a front edge of the circuit board 60. The base slice 20 is located on the left side of the circuit board 60 and connected with a rear end of the feeding portion 10.

The high frequency radiating portion 30 is located on the left side of the circuit board 60 and includes a connecting part 31 and a L-shaped radiating part 32. The connecting part 31 is connected with a left end of the base slice 20. A long arm 321 of the radiating part 32 is connected with a rear side of the connecting part 31 and is located adjacent to a left edge of the circuit board 60. A short arm 322 of the radiating part 32 extends opposite to the left edge of the circuit board 60 and is further adjacent to a rear edge of the circuit board 60.

The low frequency radiating portion 40 is connected with a rear end of the base slice 20 and zigzag meanders opposite to the high frequency radiating portion 30 along the rear edge of the circuit board 60. In this embodiment, the low frequency radiating portion 40 meanders substantially like a plurality of series-connected zigzags and has a variable amplitude and density in process of meandering according to different radiating frequencies. A free arm of the low frequency radiating portion 40 is adjacent to a right edge of the circuit board 60.

The mid-frequency radiating portion 50 is connected with the rear end of the base slice 20 and then straightly extends towards the right edge of the circuit board 60 to be located closely in front of the low frequency radiating portion 40.

As described above, the multi-band antenna utilizes the rational layout of the high frequency radiating portion 30, the low frequency radiating portion 40 and the mid-frequency radiating portion 50 on the circuit board 60 to receive and transmit communication signals of different frequency bands of 2300-2700 MHZ, 791-960 MHZ, and 1710-2170 MHZ. So the multi-band antenna is capable of conforming to the miniaturization trend of electronic products and further ensures the effective performance thereof.

What is claimed is:

1. A multi-band antenna disposed on a circuit board, comprising:
a feeding portion of a substantially rectangular slice shape located on a left side of the circuit board and adjacent to a front edge of the circuit board;
a base slice located on the left side of the circuit board and connected with a rear end of the feeding portion;
a high frequency radiating portion located on the left side of the circuit board and connected with a left end of the base slice, the high frequency radiating portion being further adjacent to a left edge and a rear edge of the circuit board;
a low frequency radiating portion connected with a rear end of the base slice and zigzag meandering opposite to the high frequency radiating portion along the rear edge of the circuit board, a free arm of the low frequency radiating portion being adjacent to a right edge of the circuit board; and
a mid-frequency radiating portion connected with the rear end of the base slice and then straightly extending towards the right edge of the circuit board to be located closely in front of the low frequency radiating portion.

2. The multi-band antenna as claimed in claim 1, wherein the high frequency radiating portion includes a connecting part and a L-shaped radiating part, the connecting part is connected with the left end of the base slice, a long arm of the radiating part is connected with a rear side of the connecting part and is located adjacent to the left edge of the circuit board, a short arm of the radiating part extends opposite to the left edge of the circuit board and is further adjacent to the rear edge of the circuit board.

3. The multi-band antenna as claimed in claim 1, wherein the low frequency radiating portion meanders substantially like a plurality of series-connected zigzags, and has a variable amplitude and density in process of meandering according to different radiating frequencies.
